(19) United States
(12) Patent Application Publication
(10) Pub. No.: US 2006/0288218 A1
(43) Pub. Date: Dec. 21, 2006

(54) Protecting ink strokes from duplication

(75) Inventor: Krishna Kotipalli, Issaquah, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/152,056

(22) Filed: Jun. 15, 2005

(51) Int. Cl. H04L 9/00

(52) U.S. Cl. 713/176

(57) ABSTRACT

Aspects of the present invention relate to selectively protecting electronic ink (e.g., digitized or captured electronic signatures) from duplication.

### BACKGROUND

In addition to working with text input, computers now have the ability to record and modify electronic ink. Electronic ink may be kept in its native form or may be run through an analyzer to recognize text, drawings and annotations. Software applications are integrating the use and analysis of electronic ink into their functionality, enhancing the ability of users to create and edit documents.

In some circumstances, users of software applications may wish to secure electronic ink to prevent copying or unauthorized use of particular collections of electronic ink. For example, a user may use electronic ink to add their written signature to a word processing document. Other than completely preventing others' access to the entire document, there is currently no way to prevent another user from copying or printing the electronic ink signature. This deficiency may cause users to avoid using electronic ink due to fears of unauthorized use.

Methods and systems are needed to enable users and software applications to secure electronic ink

### SUMMARY

Provided are methods for protecting electronic ink (e.g., signatures input on a tablet computer) from unwanted duplication. A user may select one or more ink strokes and assign protection settings for the selected strokes.

### DRAWINGS

The present invention is illustrated, by way of example and not limitation, in the accompanying figures in which like reference numerals indicate similar elements and in which:

FIG. 1A illustrates a schematic diagram of a general-purpose digital computing environment in which certain aspects of the present invention may be implemented;

FIGS. 1B through 1M illustrate programming interfaces supporting one or more aspects of the present invention;

FIG. 2 shows an illustrative example of a tablet computer in accordance with aspects of the present invention;

FIG. 3 shows an illustrative example of a software application enabling the use of electronic ink in accordance with aspects of the present invention;

FIG. 4 depicts an illustrative example of an interface for protecting electronic ink in accordance with aspects of the present invention;

FIG. 5A-5D depict illustrative examples of the visual display of protected electronic ink in accordance with aspects of the present invention;

FIG. 6 depicts an illustrative example of the constituent strokes of an electronic ink object in accordance with aspects of the present invention;

FIG. 7 depicts an illustrative example of creating a protected ink object in accordance with aspects of the present invention;

FIG. 8 depicts an example of saving and loading an unprotected ink object;

FIG. 9 depicts an illustrative example of saving and loading a protected ink object in accordance with aspects of the present invention; and

FIG. 10 is a flow chart illustrating a method for protecting electronic ink strokes from duplication in accordance with aspects of the present invention.

### DETAILED DESCRIPTION

Aspects of the present invention relate to protecting electronic ink strokes from being duplicated. Additional aspects relate to providing methods to prevent copying, pasting, or saving of protected electronic ink. Further aspects relate to providing methods for displaying protected electronic ink.

It is noted that various connections are set forth between elements in the following description. It is noted that these connections in general and, unless specified otherwise, may be direct or indirect and that this specification is not intended to be limiting in this respect.

This document is divided into sections to assist the reader. These sections include: an overview, characteristics of ink, terms, general-purpose computing environment, protecting electronic ink, and a conclusion.

Overview

According to various embodiments of the invention, electronic ink strokes may need protection from duplication in order to give users the ability to protect sensitive ink strokes, such as electronic ink signatures. Protection from duplication includes preventing a collection of ink strokes from being copied to a system clipboard, preventing ink strokes from being printed to an unauthorized printer, and preventing the ink strokes from being saved for later use. Other forms of duplication may additionally be prevented. In addition, electronic ink strokes may be saved/serialized and loaded/deserialized using encryption to prevent unauthorized access of ink strokes when stored on a storage medium.

Characteristics of Ink

As known to users of pens, markers, crayons, pencils, and other marking implements, physical ink (the kind laid down on paper using pen and ink or other writing and drawing implements) may convey more information than a series of coordinates connected by line segments. For example, physical ink can reflect pen pressure (by the thickness of the ink), pen angle (by the shape of the line or curve segments and the behavior of the ink around discreet points), and the speed of the nib of the pen (by the straightness, line width, and line width changes over the course of a line or curve). Further examples include the way ink is absorbed into the fibers of paper or other surface it is deposited on. These subtle characteristics also aid in conveying the above listed properties. Because of these additional properties, emotion, personality, emphasis and so forth can be more instantaneously conveyed than with uniform line width between points.

Electronic ink (or ink) relates to the capture and display of electronic information captured when a user uses a stylus-based input device. Electronic ink refers to a sequence or any arbitrary collection of strokes, where each stroke is comprised of a sequence of points. The strokes may have been drawn or collected at the same time or may have been drawn or collected at independent times and locations and for independent reasons. The points may be represented using a variety of known techniques including Cartesian coordinates (X, Y), polar coordinates (r, θ), and other techniques as known in the art. Electronic ink may include representations of properties of real ink including pressure, angle, speed, color, stylus size, and ink opacity. Electronic ink may further include other properties including the order of how ink was deposited on a page (a raster pattern of left to right then down for most western languages), a timestamp (indicating when the ink was deposited), indication of the author of the ink, and the originating device (at least one of an identification of a machine upon which the ink was drawn or an identification of the pen used to deposit the ink) among other information. Among the characteristics described above, the temporal order of strokes and a stroke being a series of coordinates may primarily be used.

Electronic ink may be submitted for analysis and recognition. Ink representing words and paragraphs may be analyzed in order to determine what words are intended. In analyzing ink, alternative recognition solutions may arise. For example, a person may handwrite the word “theme,” but an ink analyzer may not be sure if the ink represents the single word “theme” or the words “the me” depending on the person's handwriting. As such, an ink analyzer may use rules of grammar, the context of other nearby words, and other factors to infer a more correct analysis. In so doing, the ink may store a list of alternate words which were not selected along with the binary ink information.

Terms

| Term | Definition |
|---|---|
| Ink | A sequence or set of strokes with properties. A |
| | sequence of strokes may include strokes in an |
| | ordered form. The sequence may be ordered by the |
| | time captured or by where the strokes appear on a |
| | page or in collaborative situations by the author |
| | of the ink. Other orders are possible. A set of |
| | strokes may include sequences of strokes or |
| | unordered strokes or any combination thereof. |
| | Further, some properties may be unique to each |
| | stroke or point in the stroke (for example, |
| | pressure, speed, angle, and the like). These |
| | properties may be stored at the stroke or point |
| | level, and not at the ink level. |
| Ink object | A data structure storing ink with or without |
| | properties. |
| Stroke | A sequence or set of captured points. For example, |
| | when rendered, the sequence of points may be |
| | connected with lines. Alternatively, the stroke |
| | may be represented as a point and a vector in the |
| | direction of the next point. In short, a stroke is |
| | intended to encompass any representation of points |
| | or segments relating to ink, irrespective of the |
| | underlying representation of points and/or what |
| | connects the points. |
| Document | Any electronic file that has a viewable repre- |
| | sentation and content. A document may include a |
| | web page, a word processing document, a note page |
| | or pad, a spreadsheet, a visual presentation, a |
| | database record, a form, image files, and |
| | combinations thereof. |
| Document | Any structure for representing a collection of data |
| Object | which is meaningful to the software application |
| Model | using it. A document object model may include a |
| | tree of context node, a database table, an XML |
| | document, an array of objects in memory, and so |
| | forth. A document object model may be used to |
| | store the contents of a document, render a document |
| | to a display device, sort the contents of the |
| | document, etc. |
| Render, | The process of determining how information |
| Rendered, or | (including text, graphics, and/or electronic ink) |
| Rendering | is to be displayed, whether on a screen, printed, |
| | or output in some other manner. |
| Computer- | Any available media that can be accessed by a user |
| readable | on a computer system. By way of example, and not |
| medium | limitation, “computer-readable media” may include |
| | computer storage media and communication media. |
| Computer | Includes volatile and nonvolatile, removable and |
| storage | non-removable media implemented in any method or |
| media | technology for storage of information, such as |
| | computer-readable instructions, data structures, |
| | program modules or other data. “Computer storage |
| | media” includes, but is not limited to, RAM, ROM, |
| | EEPROM, flash memory or other memory technology; |
| | CD-ROM, digital versatile disks (DVD) or other |
| | optical storage devices; magnetic cassettes, |
| | magnetic tape, magnetic disk storage or other |
| | magnetic storage devices; or any other medium that |
| | can be used to store the desired information and |
| | that can be accessed by a computer. |
| Communication | Typically embodies computer-readable instructions, |
| media | data structures, program modules or other data in a |
| | modulated data signal, such as a carrier wave or |
| | other transport mechanism, and includes any |
| | information delivery media. |
| Modulated | A signal that has one or more of its character- |
| data | istics set or changed in such a manner as to |
| signal | encode information in the signal. By way of |
| | example, and not limitation, communication media |
| | includes wired media, such as a wired network or |
| | direct-wired connection, and wireless media, such |
| | as acoustic, RF, infrared and other wireless media. |
| | Combinations of any of the above should also be |
| | included within the scope of “computer-readable |
| | media.” |

General-Purpose Computing Environment

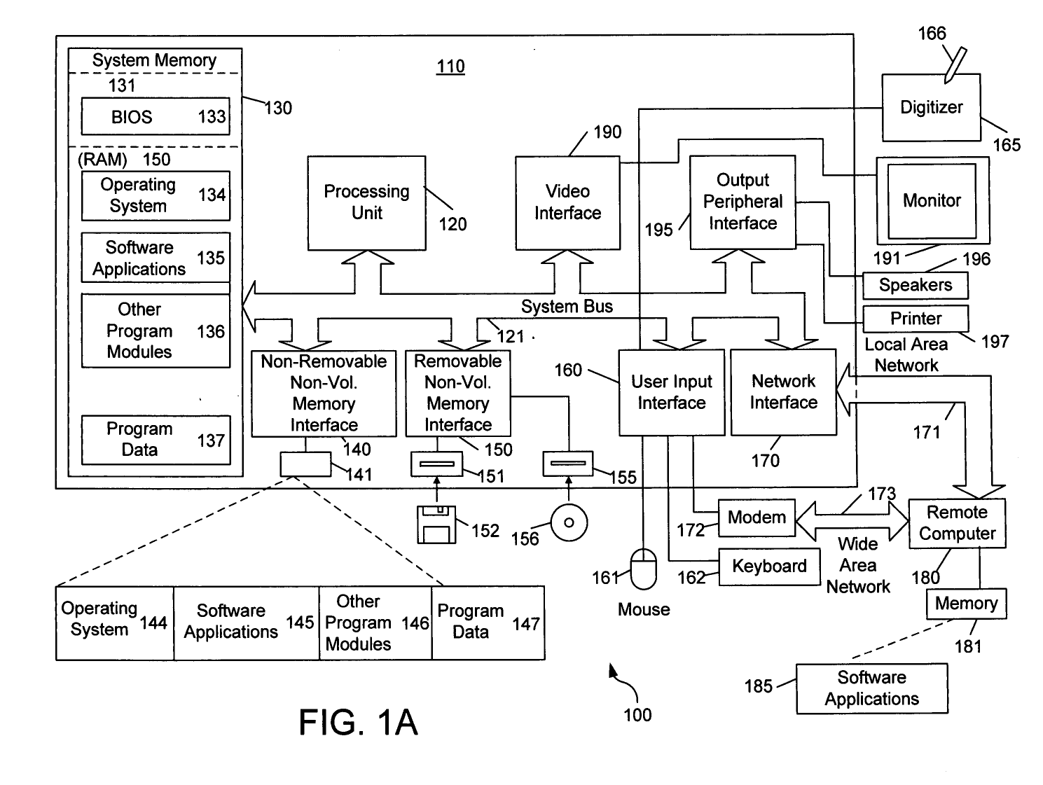

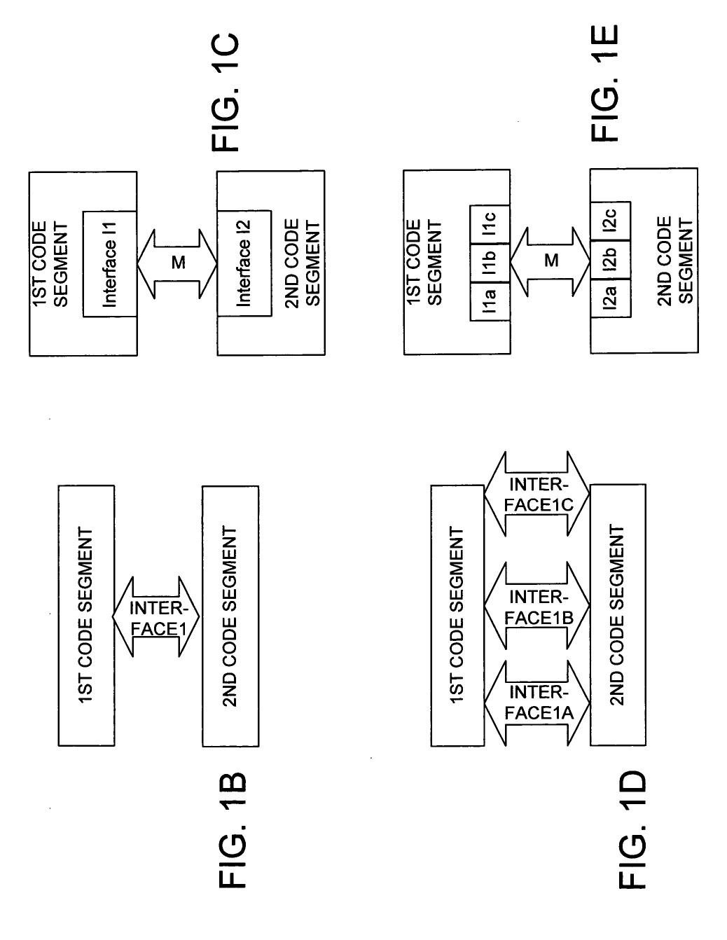

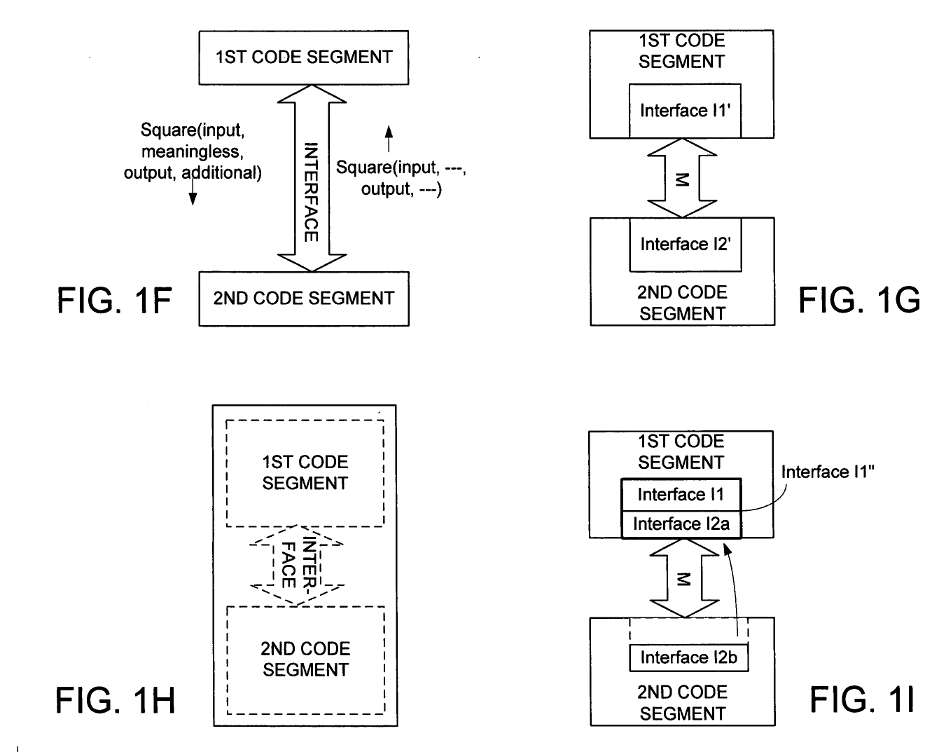

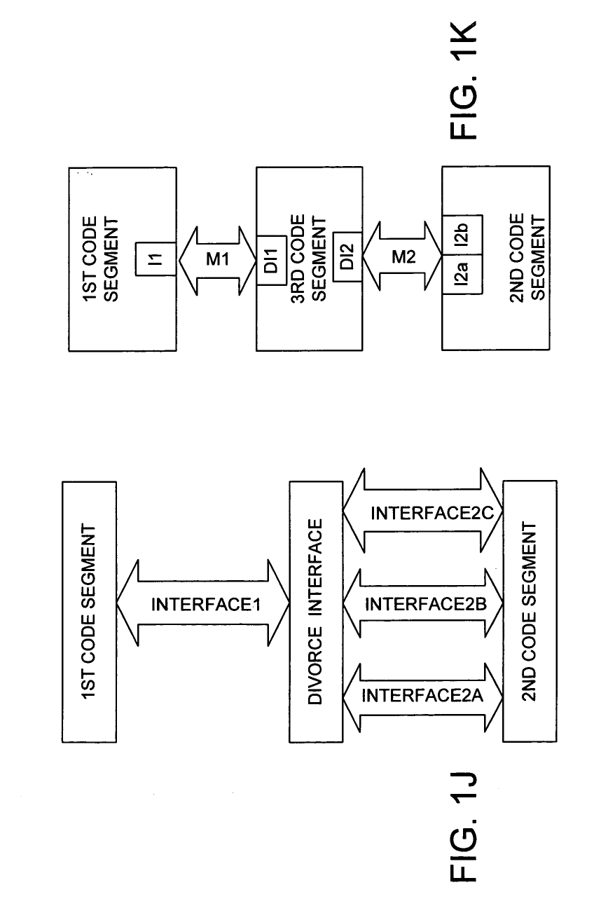

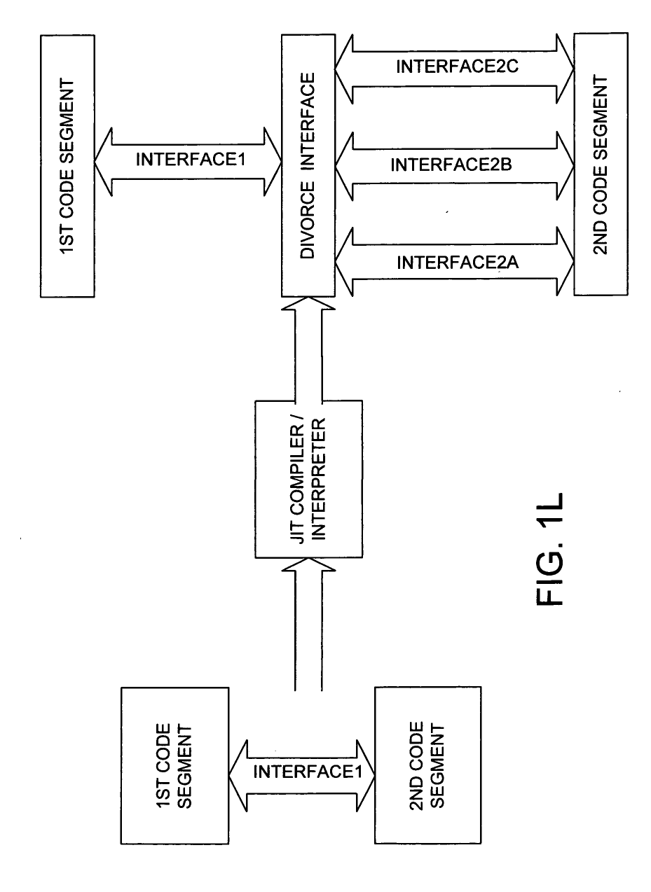

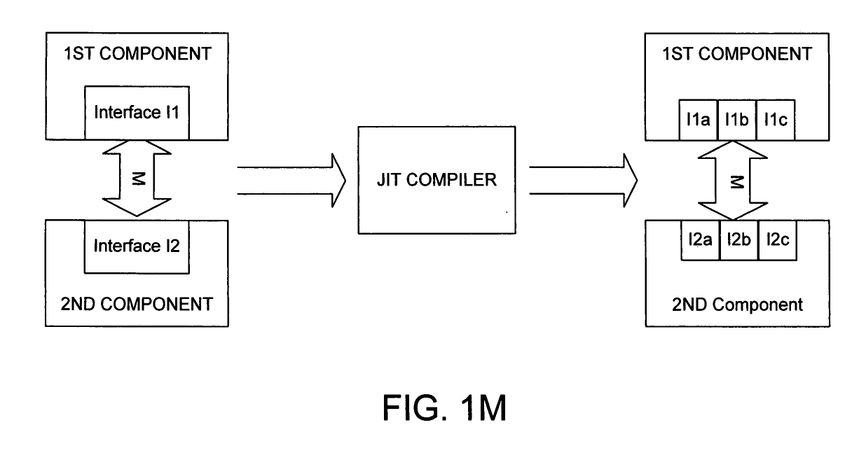

FIG. 1A illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network computers, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1A, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, and removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1A illustrates operating system 134, software applications 135, other program modules 136, and program data 137.

The computer 110 may also include other removable/non-removable, volatile/nonvolatile computer storage media. By way of example only, FIG. 1A illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1A, provide storage of computer readable instructions, data structures, program modules and other data for the computer 110. In FIG. 1A, for example, hard disk drive 141 is illustrated as storing operating system 144, software applications 145, other program modules 146, and program data 147. Note that these components can either be the same as or different from operating system 134, software applications 135, other program modules 136, and program data 137. Operating system 144, software applications 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network computer, a peer device or other common network node, and typically includes many or all of the elements described above relative to the computer 110, although only a memory storage device 181 has been illustrated in FIG. 1A. The logical connections depicted in FIG. 1A include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1A illustrates remote software applications 185 as residing on memory device 181. It will be appreciated that the network connections shown are exemplary and other means of establishing a communications link between the computers may be used.

In some aspects, a pen digitizer 165 and accompanying pen or stylus 166 are provided in order to digitally capture freehand input. Pen digitizer 165 may further use capacitive or resistive technologies enabling an active stylus or a passive stylus (e.g., a finger or other pointing device). Although a direct connection between the pen digitizer 165 and the user input interface 160 is shown, in practice, the pen digitizer 165 may be coupled to the processing unit 110 directly, parallel port or other interface and the system bus 130 by any technique including wirelessly. Also, the pen 166 may have a camera associated with it and a transceiver for wirelessly transmitting image information captured by the camera to an interface interacting with bus 130. Further, the pen may have other sensing systems in addition to or in place of the camera for determining strokes of electronic ink including accelerometers, magnetometers, and gyroscopes.

It will be appreciated that the network connections shown are exemplary and other means of establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

A programming interface (or more simply, interface) may be viewed as any mechanism, process, protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

Notionally, a programming interface may be viewed generically, as shown in FIG. 1B or FIG. 1C. FIG. 1B illustrates an interface Interface1 as a conduit through which first and second code segments communicate. FIG. 1C illustrates an interface as comprising interface objects I1 and I2 (which may or may not be part of the first and second code segments), which enable first and second code segments of a system to communicate via medium M. In the view of FIG. 1C, one may consider interface objects I1 and I2 as separate interfaces of the same system and one may also consider that objects I1 and I2 plus medium M comprise the interface. Although FIGS. 1B and 1C show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the foregoing detailed description of the invention. There are, however, other ways to implement a programming interface, and, unless expressly excluded, these too are intended to be encompassed by the claims set forth at the end of this specification. Such other ways may appear to be more sophisticated or complex than the simplistic view of FIGS. 1B and 1C, but they nonetheless perform a similar function to accomplish the same overall result. We will now briefly describe some illustrative alternative implementations of a programming interface.

### A. Factoring

A communication from one code segment to another may be accomplished indirectly by breaking the communication into multiple discrete communications. This is depicted schematically in FIGS. 1D and 1E. As shown, some interfaces can be described in terms of divisible sets of functionality. Thus, the interface functionality of FIGS. 1B and 1C may be factored to achieve the same result, just as one may mathematically provide 24, or 2 times 2 times 3 times 2. Accordingly, as illustrated in FIG. 1D, the function provided by interface Interface1 may be subdivided to convert the communications of the interface into multiple interfaces Interface1A, Interface1B, Interface1C, etc. while achieving the same result. As illustrated in FIG. 1E, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1st code segment need not match the number of interfaces included with the 2nd code segment. In either of the cases of FIGS. 1D and 1E, the functional spirit of interfaces Interface1 and I1 remain the same as with FIGS. 1B and 1C, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

### B. Redefinition

In some cases, it may be possible to ignore, add or redefine certain aspects (e.g., parameters) of a programming interface while still accomplishing the intended result. This is illustrated in FIGS. 1F and 1G. For example, assume interface Interface1 of FIG. 1B includes a function call Square (input, precision, output), a call that includes three parameters, input, precision and output, and which is issued from the 1st Code Segment to the 2nd Code Segment. If the middle parameter precision is of no concern in a given scenario, as shown in FIG. 1F, it could just as well be ignored or even replaced with a meaningless (in this situation) parameter. One may also add an additional parameter of no concern. In either event, the functionality of square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 1G, interface I1 is replaced by interface I1′, redefined to ignore or add parameters to the interface. Interface I2 may similarly be redefined as interface I2′, redefined to ignore unnecessary parameters, or parameters that may be processed elsewhere. The point here is that in some cases a programming interface may include aspects, such as parameters, which are not needed for some purpose, and so they may be ignored or redefined, or processed elsewhere for other purposes.

### C. Inline Coding

It may also be feasible to merge some or all of the functionality of two separate code modules such that the “interface” between them changes form. For example, the functionality of FIGS. 1B and 1C may be converted to the functionality of FIGS. 1H and 1I, respectively. In FIG. 1H, the previous 1st and 2nd Code Segments of FIG. 1B are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface1 may still be in effect. Similarly, shown in FIG. 11, part (or all) of interface I2 from FIG. 1C may be written inline into interface I1 to form interface I1″. As illustrated, interface I2 is divided into I2a and I2b, and interface portion I2a has been coded in-line with interface I1 to form interface I1″. For a concrete example, consider that the interface I1 from FIG. 1C performs a function call square (input, output), which is received by interface I2, which after processing the value passed with input (to calculate the square of an input) by the second code segment, passes back the squared result with output. In such a case, the processing performed by the second code segment (squaring input) can be performed by the first code segment without a call to the interface.

### D. Divorce

A communication from one code segment to another may be accomplished indirectly by breaking the communication into multiple discrete communications. This is depicted schematically in FIGS. 1J and 1K. As shown in FIG. 1J, one or more piece(s) of code (Divorce Interface(s), since they divorce functionality and/or interface functions from the original interface) are provided to convert the communications on the first interface, Interface1, to conform them to a different interface, in this case interfaces Interface2A, Interface2B and Interface2C. This might be done, e.g., where there is an installed base of software applications designed to communicate with, say, an operating system in accordance with an Interface1 protocol, but then the operating system is changed to use a different interface, in this case interfaces Interface2A, Interface2B and Interface2C. The point is that the original interface used by the 2nd Code Segment is changed such that it is no longer compatible with the interface used by the 1st Code Segment, and so an intermediary is used to make the old and new interfaces compatible. Similarly, as shown in FIG. 1K, a third code segment can be introduced with divorce interface DI1 to receive the communications from interface I1 and with divorce interface DI2 to transmit the interface functionality to, for example, interfaces I2a and I2b, redesigned to work with DI2, but to provide the same functional result. Similarly, DI1 and DI2 may work together to translate the functionality of interfaces I1 and I2 of FIG. 1C to a new operating system, while providing the same or similar functional result.

### E. Rewriting

Yet another possible variant is to dynamically rewrite the code to replace the interface functionality with something else but which achieves the same overall result. For example, there may be a system in which a code segment presented in an intermediate language (e.g. Microsoft IL, Java ByteCode, etc.) is provided to a Just-in-Time (JIT) compiler or interpreter in an execution environment (such as that provided by the .Net framework, the Java runtime environment, or other similar runtime type environments). The JIT compiler may be written so as to dynamically convert the communications from the 1st Code Segment to the 2nd Code Segment, i.e., to conform them to a different interface as may be required by the 2nd Code Segment (either the original or a different 2nd Code Segment). This is depicted in FIGS. 1L and 1M. As can be seen in FIG. 1L, this approach is similar to the Divorce scenario described above. It might be done, e.g., where an installed base of software applications are designed to communicate with an operating system in accordance with an Interface1 protocol, but then the operating system is changed to use a different interface. The JIT Compiler could be used to conform the communications on the fly from the installed software applications to the new interface of the operating system. As depicted in FIG. 1M, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 1B and 1C. It is also noted that, as with most programming constructs, there are other similar ways of achieving the same or similar functionality of an interface which may not be described herein, but nonetheless are represented by the spirit and scope of the invention, i.e., it is noted that it is at least partly the functionality represented by, and the advantageous results enabled by, an interface that underlie the value of an interface.

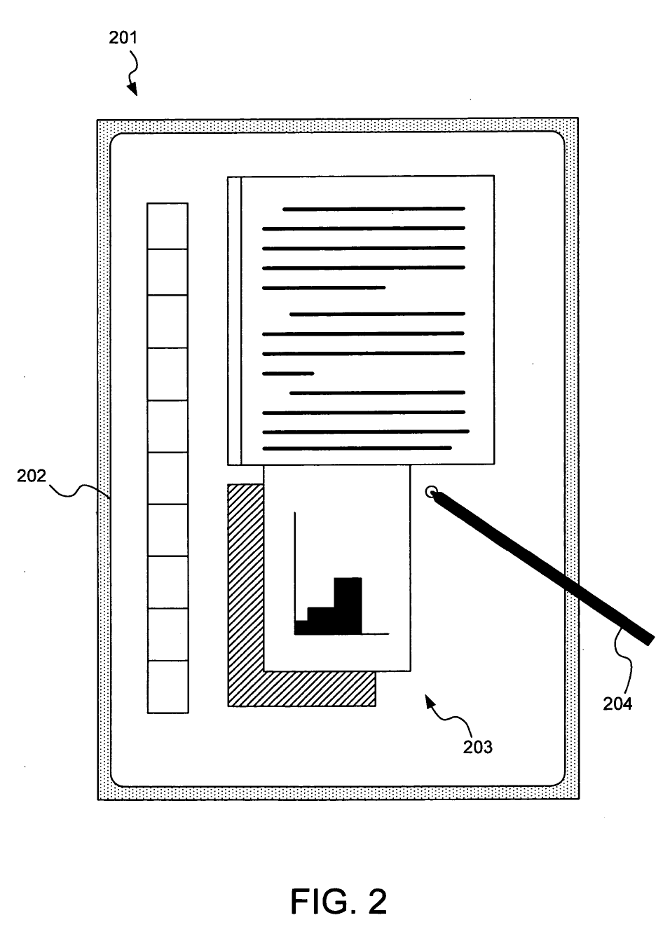

FIG. 2 illustrates an illustrative tablet computer 201 that can be used in accordance with various aspects of the present invention. Any or all of the features, subsystems, and functions in the system of FIG. 1A can be included in the computer of FIG. 2. Tablet computer 201 includes a large display surface 202, e.g., a digitizing flat panel display, preferably, a liquid crystal display (LCD) screen, on which a plurality of windows 203 is displayed. Using stylus 204, a user can select, highlight, and/or write on the digitizing display surface 202. Examples of suitable digitizing display surfaces 202 include electromagnetic pen digitizers, such as Mutoh or Wacom pen digitizers. Other types of pen digitizers, e.g., optical digitizers, may also be used. Tablet computer 201 interprets gestures made using stylus 204 in order to manipulate data, enter text, create drawings, navigate menus, and/or execute and control conventional software applications such as spreadsheets, word processing programs, and the like.

The stylus 204 may be equipped with one or more buttons or other features to augment its selection capabilities. In one embodiment, the stylus 204 could be implemented as a “pencil” or “pen”, in which one end constitutes a writing portion and the other end constitutes an “eraser” end, and which, when moved across the display, indicates portions of the display are to be erased. Other types of input devices, such as a mouse, trackball, or the like could be used. Additionally, a user's own finger could be the stylus 204 and used for selecting or indicating portions of the displayed image on a touch-sensitive or proximity-sensitive display. Consequently, the term “user input device”, as used herein, is intended to have a broad definition and encompasses many variations on well-known input devices such as stylus 204.

In various embodiments, the system provides an ink platform as a set of COM (component object model) services that a software application can use to capture, manipulate, and store ink. One service enables a software application to read and write ink using the disclosed representations of ink. The ink platform may also include a mark-up language including a language similar to extensible markup language (XML). Further, the system may use DCOM (distributed component object model) for other implementations. Yet further implementations may use programming models such as the Win32 programming model or the .Net programming model from Microsoft Corporation.

Protecting Electronic Ink

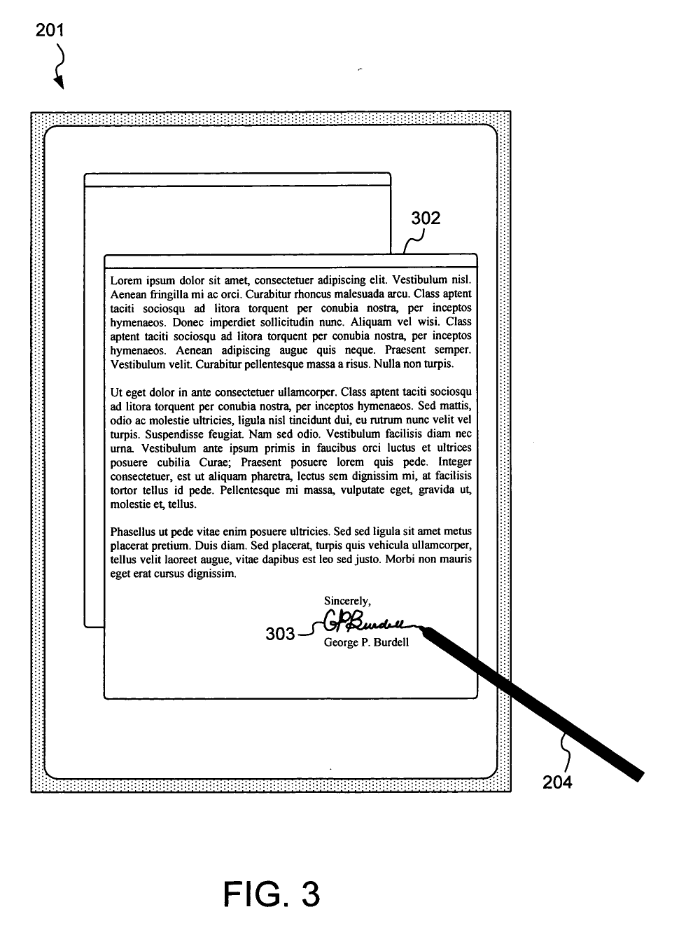

FIG. 3 shows an illustrative example of a software application enabling the use of electronic ink in accordance with aspects of the present invention. Tablet computer 201 has a software application running, perhaps a word processing program. The software application is able to work with electronic ink, and thus a user is able to annotate text or images, sketch drawings, sign their name, and so forth. Here, software application window 302 shows a typed letter which contains a signature block. For instance, user George P. Burdell has used stylus 204 to create an electronic ink signature 303. If the document shown in software application window 302 is saved, and possibly opened by an unauthorized individual, they may be able to copy electronic ink signature 303 and paste it into another document, thereby forging George's signature.

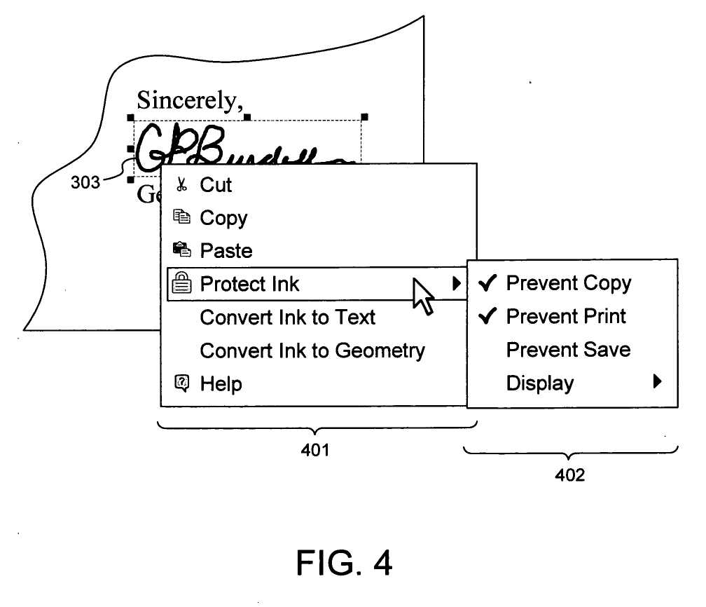

FIG. 4 depicts an illustrative example of an interface for protecting electronic ink such as electronic ink signature 303 from duplication. Once a user has created electronic ink strokes, he or she can select a collection of strokes, such as those constituting signature 303. Stroke selection may be accomplished using any number of approaches (e.g., drawing a selection boundary around the strokes). Once a collection of strokes is selected, a software application implementing the invention may utilize any number of input methods in order to allow the user to trigger ink protection. For example, the software application may include an ink protection menu option or options in an application's main menu. Or, the software application may allow keyboard shortcuts to automatically enable ink protection. Alternatively, the software application may automatically trigger ink protection without user input.

The word processor of FIG. 4 has implemented ink protection as an in-place menu option. Such in-place menus may be triggered using a designated mouse button, or a keyboard shortcut. Once the topmost menu 401 is displayed, a user may navigate to an ink protection option, here labeled “Protect Ink” with a closed lock icon. The lock icon may display an unlocked or open lock when the selected ink strokes are unprotected. Once the user hovers over or selects the ink protection option, a submenu 402 is displayed providing additional settings and options for protecting the selected ink strokes.

Ink protection choices displayed by submenu 402 here include “Prevent Copy,” “Prevent Print,” “Prevent Save,” and further “Display” options. If a user selects a series of ink strokes and opts to “Prevent Copy,” then strokes are protected such that when a user attempts to copy the strokes, he is unable to complete the operation, possibly with or without feedback.

Likewise, if a user opts to “Prevent Print,” when a user attempts to print a document containing the protected ink strokes, he or she may not be able to print the page, or alternatively the page will print without the protected ink strokes. “Prevent Print” may be selected by default. The concept of print prevention can be extended to preclude the protected ink strokes from displaying on any particular unregistered display surface, including additional monitors or printers. If computer 110 is connected to multiple printers, then only particular printers may be allowed to print any particular set of protected ink strokes. For example, signatures made up of protected ink strokes may only print to a special check printer, but not on any other connected printer. Particular printers and display surfaces may be registered with each collection of protected ink strokes.

A user selecting a collection of ink strokes and opting to “Prevent Save” will prevent the ink strokes from being saved either with the underlying document, or even saved as a file, including but not limited to an individual ink serialized format (ISF) file. This protection will carry through; even if the protected ink strokes are allowed to be copied, the copied set of protected ink strokes will not be saved.

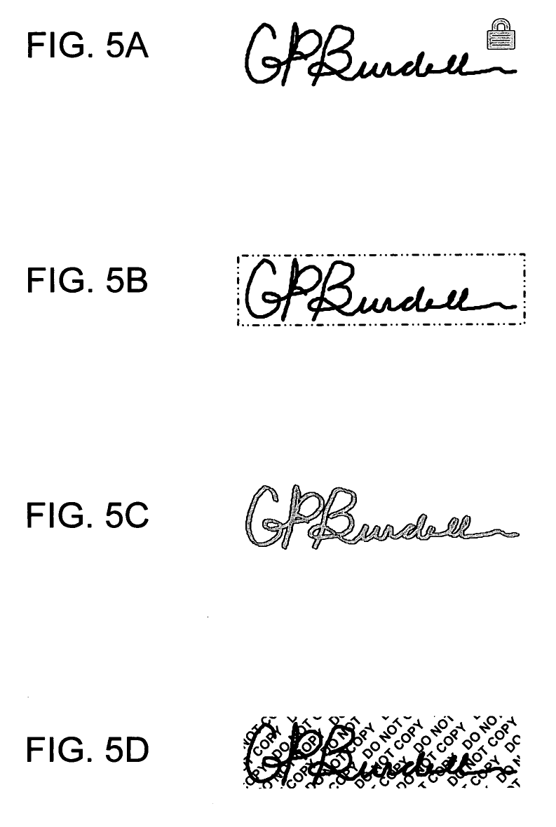

A user selecting a collection of protected ink strokes may be presented with several display options in order to visually identify the collection of strokes as protected. FIGS. 5A-5D depict illustrative examples of visually distinguishing protected electronic ink strokes. FIG. 5A shows a collection of protected ink strokes with an associated lock icon. Other icons may be used. FIG. 5B shows a collection of protected ink strokes bounded by a unique bounding box. FIG. 5C shows protected ink strokes graphically embossed to set them apart from unprotected ink strokes. Other similar visual effect may be used to set the strokes apart. FIG. 5D shows protected ink strokes with a noticeable repeating watermark. Here, the watermark states “Do Not Copy,” but alternatively the watermark may use any other text (e.g., “Do Not Print” or “Protected”), or even a graphical watermark (e.g., chain links or a lock). A watermark, text, icon, or graphic image may also replace the ink strokes entirely when rendered. This may serve as a visual cue to a person viewing a document, letting him or her know that there is a protected ink object on the page, but not allowing the viewer to actually see the ink strokes.

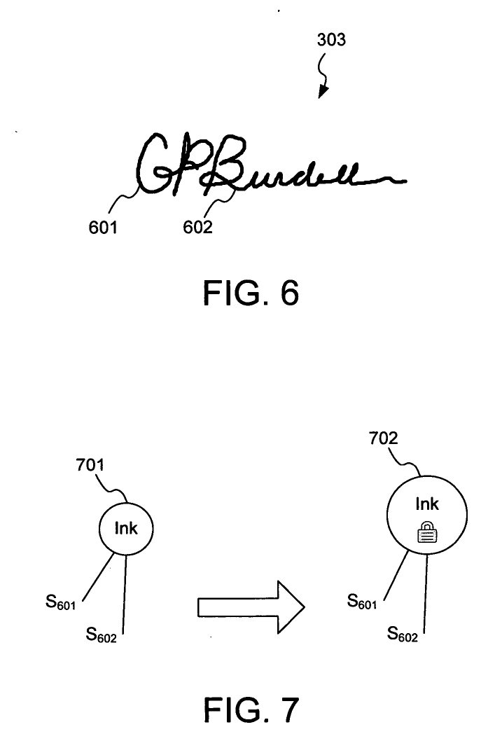

FIG. 6 depicts one possible breakdown of the constituent unprotected ink strokes of an electronic ink object such as electronic ink signature 303. Here, signature 303 is a collection of two strokes 601 and 602. When ink strokes are collected, they may be associated with a parent ink object in part to contain proximate ink strokes in a common object. FIG. 7 displays how unprotected ink strokes 601, 602 may be associated with unprotected ink object 701. Ink object 701, in addition to serving as a container for strokes 601, 602, may also provide other information about the strokes, possibly including text recognized by an ink analysis application.

When ink strokes are to be protected, they may be moved from unprotected ink object 701 to protected ink object 702, which includes functions and features to protect the ink strokes from unauthorized duplication. The process of moving the ink strokes may be as simple as reassigning a reference from an unprotected ink object to a protect ink object. In addition, other properties and objects may be copied or reassigned (e.g., recognized text). A conversion function may transform the ink object from unprotected to protected. The additional functions and features of protected ink object 702 may take the form of a derived programming interface, derived from the ink object interface implemented by ink object 702. Or the protected ink object may be a subclass of the ink object class. Alternatively, all ink objects may include the protected ink object functions and features, using them only when needed.

Protected ink objects may include new methods and attributes not found in their unprotected equivalents. New methods may include the following:

SetProtect: Sets protection flags for different forms of ink protection described above. An implementing software application may call this method when modifying the types of duplication protection for the object and associated strokes.

GetProtect: Reads the protection flags previously set.

RegisterRenderSurface: Registers a particular render surface (e.g., printer, monitor, etc.) as being safe for rendering.

RemoveRenderSurface: Removes a previously registered render surface.

Render: Renders associated ink strokes when called, so long as rendering is allowable as indicated by the protection flags, and so long as the render surface is properly registered. If a particular display option (e.g., watermark or emboss) is selected, the function will render the ink strokes and background accordingly.

Save: Creates a serialized version of a protected ink object and associated ink strokes. Encrypts the serialized version to prevent unauthorized access using a cryptographic key provided by an implementing software application.

Load: Decrypts and deserializes a previously encrypted serialized version of a protected ink object and associated ink strokes. Decrypts the serialized version using a cryptographic key provided by an implementing software application.

New constants may be created as part of the protected ink object interface/class. These may define the flags for the types of ink stroke protections invoked (e.g., prevent copy, prevent save). Also defined may be flags indicating different types of visual render effects (e.g., watermark or emboss). Additional attributes, such as a watermark bitmap, may also be added to the protected ink object.

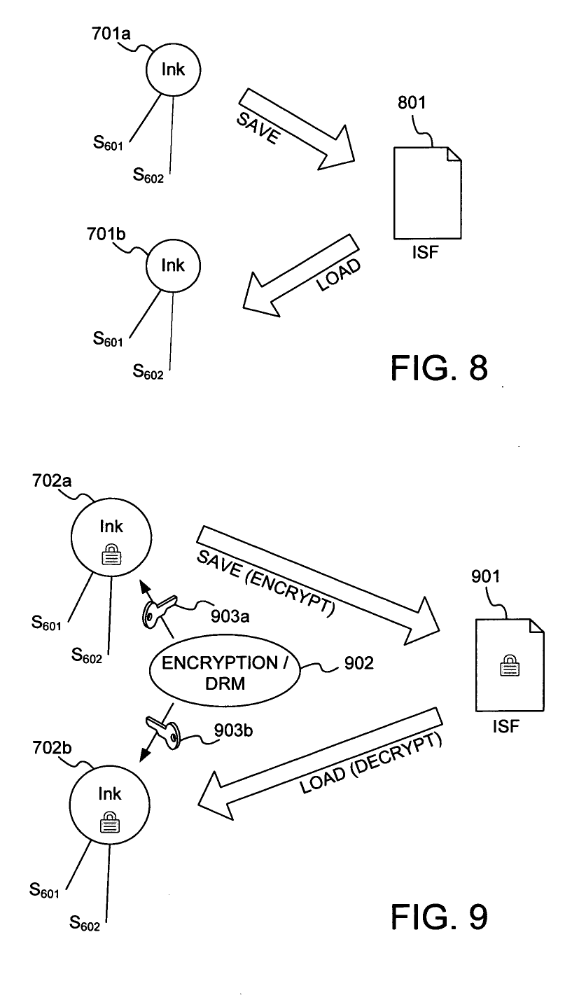

FIG. 8 depicts an example of saving unprotected ink object 701a to an ink serialized format (ISF) stream 801. Also shown is the loading and reconstituting of unprotected ink object 701b from ISF stream 801. In addition to containing all the information about associated strokes 601, 602, ISF stream 801 may contain other state information about ink object 701a (e.g., recognized text). If ISF stream 801 is saved to an accessible storage medium, an unauthorized user may be able to access and load the stream herself, thereby accessing the ink strokes and other information.

FIG. 9 depicts an illustrative example of saving and loading protected ink object 702a in accordance with aspects of the present invention. When a software application saves or serializes a protected ink object, it may provide a first cryptographic key 903a as supplied by an encryption and/or digital rights management (DRM) component 902. Additional information may be needed for the encryption process, such as additional cryptographic hashes. In this fashion, an encrypted ISF stream 901 is created which can be safely placed in a storage medium for later use (although safety depends on the strength of the encryption).

When loading and reconstituting protected ink object 702b and its constituent ink strokes 601, 602, a software application may provide a second cryptographic key 903b in order for the encrypted ISF stream 901 to be decrypted. Second cryptographic key 903b may or may not be the same as first key 903a, depending on whether the chosen encryption scheme is symmetrical (single private key) or asymmetrical (separate public and private keys).

Under this scheme, it would be the responsibility of a software application using protected ink objects to determine encryption strength, manage encryption and decryption keys, monitor the rights of users to access various protected ink objects (also known as digital rights management (DRM)), and so forth. Other schemes may be used to securely save and load the contents of a protected ink object. For example, the protected ink object may handle all of the encryption and decryption internally without needing cryptographic keys to be created by a software application requesting a save or load.

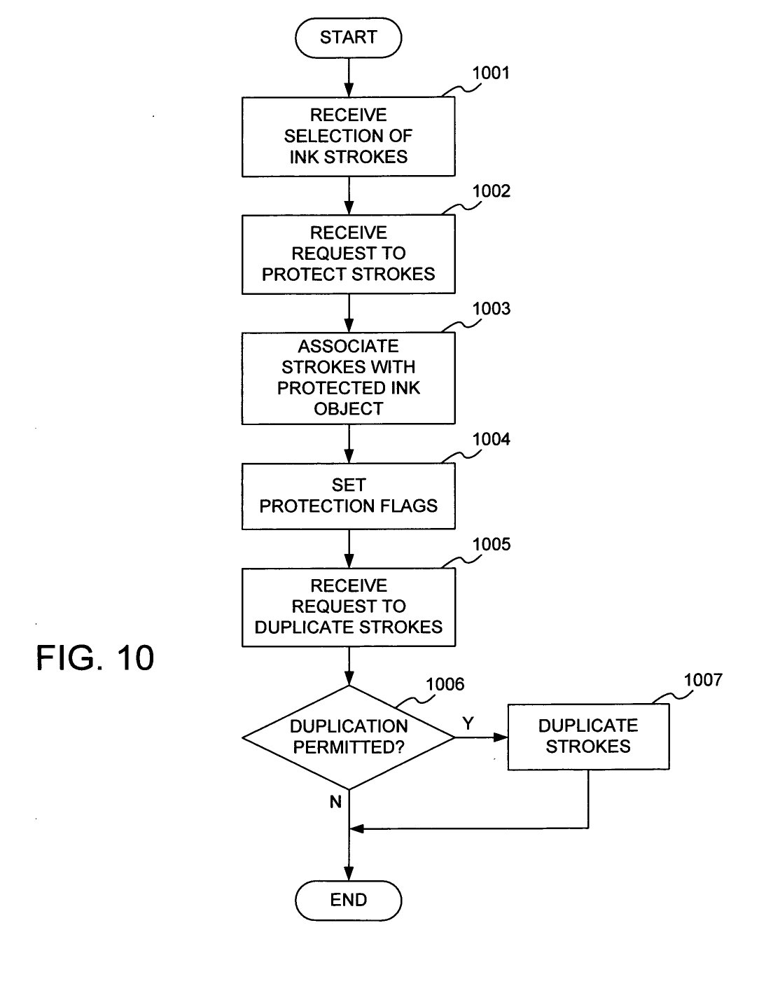

FIG. 10 is a flow chart illustrating a method for protecting electronic ink strokes from duplication in accordance with aspects of the present invention. The method provided here is but one possible method among others which are in keeping with the scope of the claims associated with this application. Individual steps may be skipped, combined and/or modified, and so the explicit steps described here should not limit the scope of the present invention.

At step 1001, a selection of one or more electronic ink strokes is received. The selection may be the result of a user explicitly selecting the displayed strokes, or the strokes may be programmatically selected by a software application automatically. At step 1002, a request to protect the strokes is received. This request may be an explicit request to create a protected ink object, or it may come as a request to apply a particular protection flag to the strokes. At step 1003, the strokes are associated with a protected ink object, which may or may not have been instantiated especially for these strokes. At step 1004, protection flags for preventing duplication in various forms are set. These protection flags may be set as a result of a request that a particular flag be set, or it may be that certain flags (e.g., a “Prevent Print” flag) are automatically set upon instantiation of the object.

At step 1005, a request is received to duplicate one ore more of the strokes associated with the protected object. Duplication may mean that a request was received to copy the strokes to the clipboard, to render the strokes to a display or printer, or to save or serialize the strokes. At decision 1006, the protection flags of the protected ink object are inspected to see if the particular type of duplication is permitted. If not, then the duplication does not occur, possibly with an error message being displayed. If duplication is permitted, then at step 1007 the duplication of the strokes is initiated. In the case of displaying or printing the strokes, an optional watermark or other visual cue denoting protected strokes may be displayed along with the strokes.

### CONCLUSION

The present subject matter has been described in terms of preferred and exemplary embodiments thereof. It is to be understood that the subject matter defined in the appended claims is not necessarily limited to the specific features or acts described above. Rather, the specific features and acts described above are disclosed as example forms of implementing the claims.

I claim:

1. A computer-implemented method for protecting electronic ink, the method comprising steps of:
receiving a selection of one or more electronic ink strokes;
receiving an input requiring protection of the one or more electronic ink strokes; and
selectively preventing the one or more electronic ink strokes from being duplicated.

2. The method of claim 1, further comprising steps of:
receiving a request to copy the one or more electronic ink strokes to a clipboard; and
refusing to comply with the request to copy the one or more electronic ink strokes.

3. The method of claim 1, further comprising the step of:
receiving a request to render the one or more electronic ink strokes on a display surface.

4. The method of claim 3, further comprising the step of:
refusing to comply with the request to render the one or more electronic ink strokes.

5. The method of claim 3, further comprising the step of:
rendering the one or more electronic ink strokes in a fashion visually denoting a protected status.

6. The method of claim 5, wherein the fashion visually denoting a protected status comprises displaying a watermark accompanying the one or more electronic ink strokes.

7. The method of claim 3, further comprising the step of:
rendering a watermark in place of the one or more electronic ink strokes.

8. The method of claim 1, further comprising steps of:
receiving a request to serialize the one or more electronic ink strokes for storage in a storage medium; and
refusing to comply with the request to serialize the one or more electronic ink strokes.

9. The method of claim 1, further comprising the steps of:
associating the one or more electronic ink strokes with one or more protected ink objects, wherein the one or more protected ink objects prevent duplication of the associated one or more electronic ink strokes.

10. The method of claim 9, further comprising the step of:
receiving a request to serialize one of the one or more protected ink objects, the request including a first cryptographic key;
generating a stream comprising the one protected ink object including any electronic ink strokes associated with the one protected ink object; and
encrypting the stream using the first cryptographic key.

11. The method of claim 10, further comprising the step of:
receiving a request to deserialize the stream, the request including a second cryptographic key;
decrypting the stream using the second cryptographic key; and
reconstituting the one protected ink object including any electronic ink strokes associated with the one protected ink object.

12. A system for protecting electronic ink strokes from duplication, the system comprising:
a storage, for storing a protected ink object including associated electronic ink strokes;
a display, for displaying a representation of the electronic ink strokes in a fashion visually denoting a protected status; and
a processor that accesses the protected ink object in the storage and controls the displayed representation of the electronic ink strokes, the processor configured to perform steps of:
(a) receiving a request to duplicate the electronic ink strokes;
(b) determining whether a type of duplication is permitted based on one or more protection attributes of the protected ink object; and
(c) responsive to the type of duplication being permitted, performing the requested duplication.

13. The system of claim 12, wherein the request to duplicate the electronic ink strokes comprises a request to save the electronic ink strokes, and wherein performing the requested duplication comprises:
(c1) creating a serialized stream of the protected ink object including the associated electronic ink strokes; and
(c2) encrypting the serialized stream.

14. The system of claim 13, wherein the processor is further configured to perform the steps of:
(d) receive a request to load the serialized stream;
(e) decrypt the serialized stream; and
(f) reconstitute the protected ink object including the associated electronic ink strokes.

15. The system of claim 12, wherein the representation of the electronic ink strokes includes the ink strokes being accompanied by a watermark.

16. The system of claim 12, wherein the representation of the electronic ink strokes includes the ink strokes being accompanied by a graphic image denoting a protected status.

17. The system of claim 12, wherein the representation of the electronic ink strokes includes a watermark being displayed in the place of the electronic ink strokes.

18. A computer-implemented method for selectively protecting electronic ink strokes from duplication, the method comprising:
receiving a selection of electronic ink strokes, wherein the selection of electronic ink strokes is presently associated with one or more ink objects;
receiving a first request to protect the selection of electronic ink strokes from duplication;
responsive to the first request, associating the selection of electronic ink strokes with a protected ink object;
receiving a second request to duplicate the selection of electronic ink strokes; and
responsive to the second request, communicating an error message.

19. The computer-implemented method of claim 18, further comprising:
receiving a third request to save the protected ink object;
responsive to the third request, serializing the protected ink object and associated electronic ink strokes; and
encrypting the serialized protected ink object and associated electronic ink strokes.

20. The computer-implemented method of claim 18, further comprising:
receiving a third request to display the protected ink object; and
responsive to the third request, displaying the protected ink object in a fashion visually denoting a protected status.
